(19) United States
(12) Patent Application Publication
(10) Pub. No.: US 2024/0223109 A1
(43) Pub. Date: Jul. 4, 2024

(54) ULTRASONIC MOTOR

(71) Applicant: Murata Manufacturing Co., Ltd., Nagaokakyo-shi (JP)

(72) Inventors: Akari HASHIMOTO, Nagaokakyo-shi (JP); Hideaki KASHIURA, Nagaokakyo-shi (JP)

(21) Appl. No.: 18/603,443

(22) Filed: Mar. 13, 2024

Related U.S. Application Data
(63) Continuation of application No. PCT/JP22/37799, filed on Oct. 11, 2022.

(30) Foreign Application Priority Data
Nov. 12, 2021 (JP) 2021-184942

(51) Int. Cl. H02N 2/00; H02N 2/10

(52) U.S. Cl. CPC H02N 2/0055; H02N 2/103

(57) ABSTRACT

An ultrasonic motor that includes a case having a first case member having a plate shape portion including a first main surface and a second main surface and a side surface connecting the first main surface and the second main surface; a first bearing portion attached to the first case member and that supports the shaft; a second case member disposed on a second main surface side of the first case member, and having a cup shape portion including a bottom portion and a side wall portion, wherein the side wall portion has a plurality of support portions that protrude toward an inside of the case and support the second main surface of the first case member, and a plurality of fixing portions that fix the first case member to the second case member; and a second bearing portion attached to the second case member and that supports the shaft.

### CROSS REFERENCE TO RELATED APPLICATIONS

The present application is a continuation of International application No. PCT/JP2022/037799, filed Oct. 11, 2022, which claims priority to Japanese Patent Application No. 2021-184942, filed Nov. 12, 2021, the entire contents of each of which are incorporated herein by reference.

### TECHNICAL FIELD

The present invention relates to an ultrasonic motor.

### BACKGROUND ART

Conventionally, there have been proposed various ultrasonic motors in each of which a stator is vibrated by a piezoelectric element. Japanese Patent Application Laid-Open No. H10-248273 (hereinafter “Patent Document 1”) discloses one example of an ultrasonic motor. In this ultrasonic motor, a stator and a rotor are housed in a case that is composed of a base and a cover. The stator is mounted on a top surface of a mounting portion of the base. The rotor is disposed above the stator. A shaft is inserted through an insertion hole of the base, a through hole of the stator, and an insertion hole of the rotor. Note that the stator is fixed to the mounting portion of the base by screws, brazing, or an adhesion.

### SUMMARY OF THE INVENTION

In the ultrasonic motor described in Patent Document 1, an angular displacement of a rotation axis may occur during manufacturing, etc. of the ultrasonic motor. Therefore, a characteristic of the ultrasonic motor may deteriorate. Further, it is difficult to make the size of the ultrasonic motor sufficiently small.

The object of the present invention is to provide an ultrasonic motor that can surely suppress the angular displacement of the shaft and can be made small.

An ultrasonic motor according to the present invention includes: a shaft; a case that includes: a first case member having a plate shape portion including a first main surface and a second main surface that face opposite to each other and a side surface connecting the first main surface and the second main surface; a first bearing portion attached to the first case member and that supports the shaft; a second case member disposed on a second main surface side of the first case member, and having a cup shape portion including a bottom portion and a side wall portion connected to the bottom portion, wherein the side wall portion of the second case member has a plurality of support portions that protrude toward an inside of the case and support the second main surface of the first case member, and a plurality of fixing portions that fix at least one of the first main surface and the side surface of the first case member to the second case member; and a second bearing portion attached to the second case member and that supports the shaft; a stator disposed in the case and having a plate-shaped vibrating body including a third main surface and a fourth main surface that face opposite to each other, and a piezoelectric element on the third main surface of the vibrating body; and a rotor disposed in the case, fixed to the shaft, and in contact with the fourth main surface of the vibrating body.

According to an ultrasonic motor of the present invention, an angular displacement of the shaft can be surely suppressed and the size of the ultrasonic motor can be made small.

### BRIEF EXPLANATION OF THE DRAWINGS

FIG. 1 is a sectional view of an ultrasonic motor according to a first embodiment of the present invention.

FIG. 2 is a perspective view of a case of the first embodiment of the present invention.

FIG. 3 is an exploded perspective view of the ultrasonic motor according to the first embodiment of the present invention.

FIG. 4 is a perspective view of a first case member of the first embodiment of the present invention.

FIG. 5 is a perspective view of a second case member of the first embodiment of the present invention.

FIG. 6 is a plan view of a stator of the first embodiment of the present invention.

FIG. 7 is a front sectional view of a first piezoelectric element of the first embodiment of the present invention.

FIGS. 8(a) to 8(c) are schematic plan views of the stator for explaining a traveling wave excited in the first embodiment of the present invention.

FIG. 9 is a front sectional view of an example of a portion close to a tip end portion of a shaft and a positioning jig of a second embodiment of the present invention.

FIG. 10 is a front sectional view of an example of a portion close to a tip end portion of a shaft and a positioning jig of a modification example of the second embodiment of the present invention.

### DETAILED DESCRIPTION OF THE PREFERRED EMBODIMENTS

Hereinafter, the present invention will be clarified by describing specific embodiments of the present invention with reference to the drawings.

Note that each of the embodiments described in the present description is an exemplary embodiment, and replacement of some part or combination of configurations is possible among different embodiments.

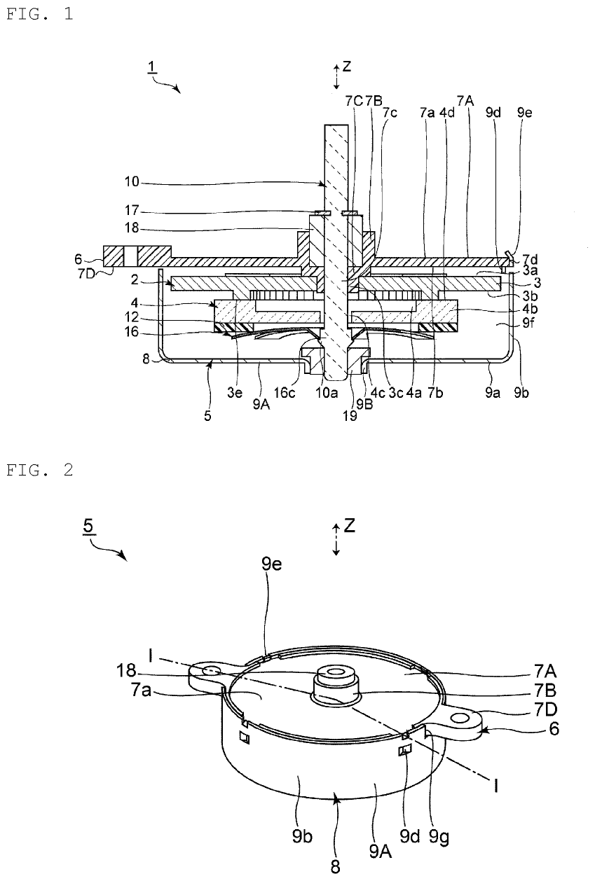

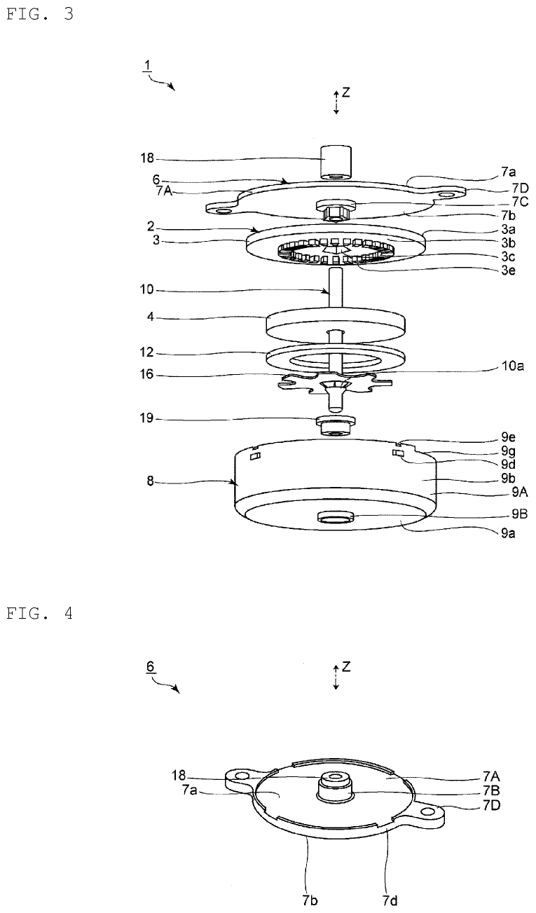

FIG. 1 is a sectional view of an ultrasonic motor according to a first embodiment of the present invention. FIG. 2 is a perspective view of a case of the first embodiment. FIG. 3 is an exploded perspective view of the ultrasonic motor according to the first embodiment. Note that FIG. 1 is a sectional view taken along a line I-I in FIG. 2.

As shown in FIG. 1, an ultrasonic motor 1 has a stator 2, a rotor 4, a case 5, and a shaft 10. The case 5 houses the stator 2 and the rotor 4. As shown in FIG. 2, the case 5 is composed of a first case member 6 and a second case member 8. With reference to FIG. 1 again, the stator 2 and the rotor 4 are in contact with each other. Specifically, the stator 2 has a vibrating body 3. The rotor 4 is in contact with one main surface of the vibrating body 3. The rotor 4 is rotated by a traveling wave generated in the stator 2. On the other hand, the shaft 10 is inserted through the stator 2 and the rotor 4 and reaches the outside of the case 5. The rotor 4 is fixed to the shaft 10. Therefore, as the rotor 4 rotates, the shaft 10 rotates.

Hereinafter, a specific configuration of the ultrasonic motor 1 will be described. In the present description, an axial direction Z is a direction that connects both main surfaces of the vibrating body 3 of the stator 2 and is a direction along a rotation center. The shaft 10 extends in parallel with the axial direction Z. In the present description, a view seen in the axial direction Z is referred to as a plan view. Note that the plan view is seen in a direction from above of FIG. 1. For example, the plan view is seen in a direction from the first case member 6 side to the second case member 8 side. Further, an inside and an outside in the present description are an inside and an outside with respect to the case 5.

FIG. 4 is a perspective view of a first case member of the first embodiment.

The first case member 6 of the present embodiment is configured as a flange. The first case member 6 has a plate shape portion 7A and a first bearing portion 18. The plate shape portion 7A includes a first main surface 7a, a second main surface 7b, and a side surface 7d. The first main surface 7a and the second main surface 7b face opposite to each other. The first main surface 7a is located on an outside surface of the case 5. As shown in FIG. 1, a central portion of the plate shape portion 7A is provided with a first protruding portion 7B and a second protruding portion 7C. The first protruding portion 7B protrudes to the outside of the case 5 from the plate shape portion 7A. The second protruding portion 7C protrudes to the inside of the case 5 from the plate shape portion 7A. Each of the first protruding portion 7B and the second protruding portion 7C extends in the axial direction Z. Each of the first protruding portion 7B and the second protruding portion 7C has a circular cylindrical shape. Note that the shape of each of the first protruding portion 7B and the second protruding portion 7C is not limited to the above and each of the first protruding portion 7B and the second protruding portion 7C only needs to have a cylindrical shape.

One continuous through hole 7c is provided to the first protruding portion 7B and the second protruding portion 7C. An inner diameter of the first protruding portion 7B is larger than an inner diameter of the second protruding portion 7C. A first bearing portion 18 is provided in the first protruding portion 7B. The shaft 10 is inserted through the first bearing portion 18. The shaft 10 passes through the first bearing portion 18 and protrudes to the outside of the case 5. Note that the first case member 6 may not be provided with the second protruding portion 7C.

As shown in FIG. 3, the first case member 6 further has a mounting portion 7D. The mounting portion 7D protrudes from the plate shape portion 7A in a direction orthogonal to the axial direction Z. The ultrasonic motor 1 is mounted to an external part via the mounting portion 7D. In the present embodiment, the plate shape portion 7A has a disk shape. However, the shape of the plate shape portion 7A is not limited to the disk shape. The first case member 6 may not necessarily have the mounting portion 7D.

The plate shape portion 7A, the first protruding portion 7B, the second protruding portion 7C, and the mounting portion 7D of the first case member 6 are made of resin. However, material of which each of the above-described portions of the first case member 6 is made is not limited to resin and, for example, may be metal or ceramics.

The second case member 8 is disposed on the second main surface 7b side of the first case member 6. The second case member 8 has a cup shape portion 9A and a second bearing portion 19. The cup shape portion 9A includes a bottom portion 9a and a side wall portion 9b. The side wall portion 9b is connected to the bottom portion 9a. As shown in FIG. 1, the cup shape portion 9A includes an opening 9f. The opening 9f is surrounded by the bottom portion 9a and the side wall portion 9b. A center portion of the bottom portion 9a is provided with a protruding portion 9B. The protruding portion 9B protrudes to the outside of the case 5 from the bottom portion 9a. The protruding portion 9B has a circular cylindrical shape. Note that the shape of the protruding portion 9B is not limited to the above and the protruding portion 9B only need to have a cylindrical shape.

A second bearing portion 19 is provided in the protruding portion 9B. The shaft 10 is inserted through the second bearing portion 19. The shaft 10 passes through the second bearing portion 19 and protrudes to the outside of the case 5. For example, metal, ceramics, or resin, etc. can be used as material of the cup shape portion 9A and the protruding portion 9B of the second case member 8.

A sliding bearing made of resin is preferably used as each of the first bearing portion 18 and the second bearing portion 19. However, material of each of the first bearing portion 18 and the second bearing portion 19 is not limited to resin. Further, each of the first bearing portion 18 and the second bearing portion 19 is not limited to the sliding bearing and, for example, may be a bearing.

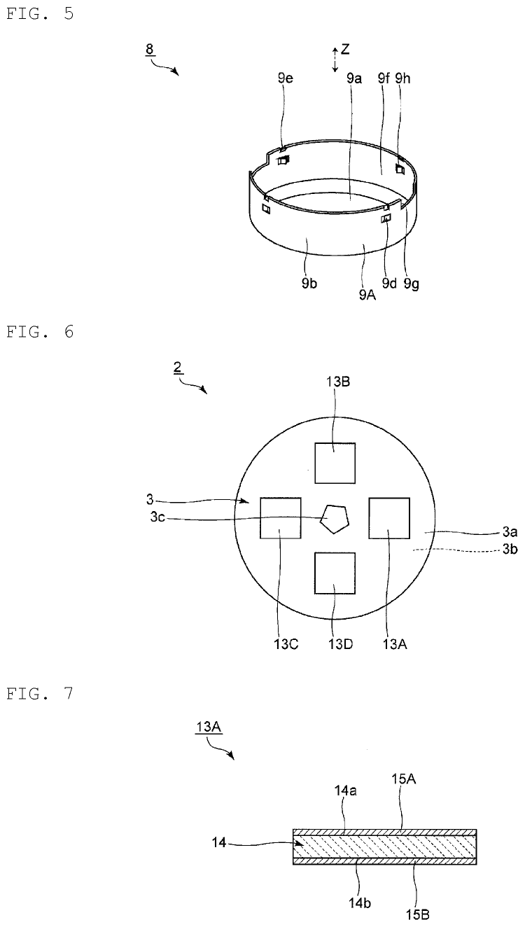

FIG. 5 is a perspective view of the second case member of the first embodiment.

The side wall portion 9b of the second case member 8 has four support portions 9d. Each support portion 9d is a portion that protrudes from the side wall portion 9b to the inside (side of the center of the shaft). Each support portion 9d supports the first case member 6. In the present embodiment, each support portion 9d is a cut and raised portion. The cut and raised portion is a portion of the side wall portion 9b that is cut and raised from the outside to the inside. Further, the side wall portion 9b has four fixing portions 9e. Each fixing portion 9e of the second case member 8 fixes the first case member 6 by a crimp structure described below. Each fixing portion 9e has a configuration in which a part of an opening end portion of the side wall portion 9b is folded to the inside. Specifically, when the ultrasonic motor 1 is manufactured, each fixing portion 9e of the present embodiment is formed by folding a part of the opening end portion of the side wall portion 9b by the crimp structure. In this case, the inside indicated in the configuration of the support portion 9d and the fixing portion 9e is the inside of the case 5 in a direction orthogonal to the axial direction Z. Note that the configuration of the support portion 9d and the fixing portion 9e is not limited to the above.

As shown in FIG. 1, the first case member 6 is fixed by the crimp structure made by each fixing portion 9e. Specifically, the plurality of support portions 9d and the plurality of fixing portions 9e overlap with each other in plan view. The plate shape portion 7A of the first case member 6 is held between the fixing portion 9e and the support portion 9d. Thereby, the first case member 6 is fixed to the second case member 8.

The feature of the present embodiment is that the side wall portion 9b of the second case member 8 has at least three of the plurality of support portions 9d and at least three of the plurality of fixing portions 9e, and that the first case member 6 is fixed by the plurality of fixing portions 9e. According to the above, the angular displacement of the shaft 10 can be surely suppressed and the size of the ultrasonic motor can be made small. Hereinafter, this will be described.

When the ultrasonic motor 1 is manufactured, the first case member 6 is fixed to the second case member 8 with the shaft 10 being inserted through the first case member 6 and the second case member 8, and thereby the case 5 is formed. When the first case member 6 is fixed to the second case member 8 as described above, force is applied in a direction in which the first case member 6 and the second case member 8 contact closely to each other in the axial direction Z. In this case, since three or more of the support portions 9d support the first case member 6, the position of the first case member 6 can be stabilized. According to the above, the position of the shaft 10 can also be stabilized and the tilt of the shaft 10 can be suppressed. In addition, since three or more of the fixing portions 9e fix the first case member 6, force can be uniformly applied to the first case member 6. According to the above, the positional displacement and tilt of the first case member 6 with respect to the second case member 8 can be surely suppressed. Thus, the perpendicularity of the shaft 10 can be surely increased. Therefore, the angular displacement of the shaft 10 can be surely suppressed. Note that the perpendicularity is a perpendicularity with respect to the reference plane of the first case member 6. The reference plane of the first case member 6 may be the first main surface 7a of the plate shape portion 7A, or may be the second main surface 7b.

Further, in the present embodiment, the first case member 6 is fixed by the second case member 8 with the crimp structure. Thus, the first case member 6 and the second case member 8 do not need screws or the like. Therefore, the height of the ultrasonic motor 1 can be decreased and the ultrasonic motor 1 can be made small.

Hereinafter, the configuration of the present embodiment will be described in more detail.

As shown in FIG. 1, the shaft 10 is provided with a snap ring 17. The snap ring 17 has an annular shape. In plan view, the snap ring 17 surrounds the shaft 10. More specifically, an inner peripheral end edge portion of the snap ring 17 is located in the shaft 10. The snap ring 17 is in contact with the first bearing portion 18 from the outside in the axial direction Z. As a result, the angular displacement of the shaft 10 can be suppressed. As material of the shaft 10 and the snap ring 17, for example, metal or resin can be used.

FIG. 6 is a plan view of the stator of the first embodiment.

The stator 2 has a vibrating body 3. The vibrating body 3 has a disk shape. The vibrating body 3 has a third main surface 3a and a fourth main surface 3b. The third main surface 3a and the fourth main surface 3b face opposite to each other. A through hole 3c is provided in a central portion of the vibrating body 3. The second protruding portion 7C of the first case member 6 is inserted through the through hole 3c.

Note that, the position of the through hole 3c is not limited to the above. The through hole 3c only needs to be located in a region including the axial direction center. The shape of the through hole 3c in plan view is not particularly limited and may be, for example, a circular shape or an oval shape, or a regular polygon such as a regular hexagon, a regular octagon, or a regular decagon. Further, the shape of the vibrating body 3 is not limited to a disk shape. The shape of the vibrating body 3 in plan view may be, for example, a regular polygon such as a regular hexagon, a regular octagon, or a regular decagon. The vibrating body 3 is made of an appropriate metal. Note that the vibrating body 3 is not necessarily made of metal. The vibrating body 3 may be configured with another elastic body such as ceramics, a silicon material, or a synthetic resin.

A plurality of piezoelectric elements are provided on the third main surface 3a of the vibrating body 3. Specifically, the plurality of piezoelectric elements are a first piezoelectric element 13A, a second piezoelectric element 13B, a third piezoelectric element 13C, and a fourth piezoelectric element 13D. The plurality of piezoelectric elements are dispersedly disposed along a circumferential direction of a traveling wave so as to generate the traveling wave circulating around an axis parallel to the axial direction Z. When viewed from the axial direction Z, the first piezoelectric element 13A and the third piezoelectric element 13C face each other with the axis interposed therebetween. The second piezoelectric element 13B and the fourth piezoelectric element 13D face each other with the axis interposed therebetween.

FIG. 7 is a front sectional view of the first piezoelectric element of the first embodiment.

The first piezoelectric element 13A has a piezoelectric body 14. The piezoelectric body 14 has a fifth main surface 14a and a sixth main surface 14b. The fifth main surface 14a and the sixth main surface 14b face opposite to each other. The first piezoelectric element 13A has a first electrode 15A and a second electrode 15B. The first electrode 15A is provided on the fifth main surface 14a of the piezoelectric body 14, and the second electrode 15B is provided on the sixth main surface 14b of the piezoelectric body 14. Each of the second piezoelectric element 13B, the third piezoelectric element 13C, and the fourth piezoelectric element 13D is also configured similarly to the first piezoelectric element 13A. Each of the above-described piezoelectric elements has a rectangular shape in plan view. Note that the shape of each piezoelectric element in plan view is not limited to the above, and may be, for example, an oval shape.

Here, the first electrode 15A is attached to the third main surface 3a of the vibrating body 3 with an adhesive. The thickness of this adhesive is very thin.

Therefore, the first electrode 15A is electrically connected to the vibrating body 3.

Note that, in order to generate the traveling wave, the stator 2 only needs to have at least the first piezoelectric element 13A and the second piezoelectric element 13B. Alternatively, the stator 2 may have one piezoelectric element divided into a plurality of regions. In this case, for example, the regions of the piezoelectric element may be polarized in different directions from each other.

As shown in FIG. 3, a plurality of protrusion portions 3e are provided on the fourth main surface 3b of the vibrating body 3. The plurality of protrusion portions 3e are portions of the vibrating body 3 in contact with the rotor 4. Each protrusion portion 3e protrudes in the axial direction Z from the fourth main surface 3b of the vibrating body 3. In plan view, the plurality of protrusion portions 3e are arranged in an annular shape. Since the plurality of protrusion portions 3e protrude in the axial direction Z from another portion of the fourth main surface 3b, when the traveling wave is generated in the vibrating body 3, the tip end portions of the plurality of protrusion portions 3e are displaced more largely. The protrusion portions 3e of the fourth main surface 3b are in contact with the rotor 4. Therefore, the rotor 4 can be efficiently rotated by the traveling wave generated in the stator 2. Note that the plurality of protrusion portions 3e are not necessarily provided.

The rotor 4 has a disk shape. As shown in FIG. 1, a through hole 4c is provided on a central portion of the rotor 4. However, the position of the through hole 4c is not limited to the above. The through hole 4c only needs to be located in a region including the axial direction center. Further, the shape of the rotor 4 is not limited to the above. The shape of the rotor 4 in plan view may be, for example, a regular polygon such as a regular hexagon, a regular octagon, or a regular decagon.

The rotor 4 has a concave portion 4a and a side wall portion 4b. The concave portion 4a has a circular shape when seen in the axial direction Z. The side wall portion 4b is a portion surrounding the concave portion 4a. The rotor 4 is in contact with the stator 2 on an end surface 4d of the side wall portion 4b. However, the concave portion 4a and the side wall portion 4b may not be provided. As a material of the rotor 4, for example, metal or ceramic can be used. In the present embodiment, the rotor 4 and the shaft 10 are separately configured. However, the rotor 4 and the shaft 10 may be integrally configured.

A friction material may be fixed on a surface of the rotor 4 on the stator 2 side. According to the above, the frictional force applied between the vibrating body 3 of the stator 2 and the rotor 4 can be stabilized. In this case, the rotor 4 can be efficiently rotated, and the ultrasonic motor 1 can be efficiently rotationally driven.

An elastic member 12 is provided on the rotor 4. The elastic member 12 sandwiches the rotor 4 together with the stator 2 in the axial direction Z. The elastic member 12 has an annular shape. Note that the shape of the elastic member 12 is not limited to the above. As a material of the elastic member 12, for example, rubber or resin can be used. However, the elastic member 12 may not be provided.

A spring member 16 is disposed on the second bearing portion 19 side of the elastic member 12. Specifically, the spring member 16 of the present embodiment is a leaf spring made of metal. A through hole 16c is provided in a central portion of the spring member 16. The shaft 10 is inserted through the through hole 16c. The shaft 10 has a wide portion 10a. The width of the wide portion 10a of the shaft 10 is wider than the width of the other portion of the shaft 10. Note that the width of the shaft 10 is a dimension along a direction orthogonal to the axial direction Z of the shaft 10. An inner peripheral end edge portion of the spring member 16 is in contact with the wide portion 10a. As a result, the positional displacement between the spring member 16 and the shaft 10 can be suppressed. However, the material and configuration of the spring member 16 are not limited to the above. The configuration of the shaft 10 is also not limited to the above.

An elastic force is applied from the spring member 16 to the rotor 4 via the elastic member 12. As a result, the rotor 4 is pressed against the stator 2. In this case, frictional force between the stator 2 and the rotor 4 can be increased. Thus, the traveling wave can be effectively propagated from the stator 2 to the rotor 4, and the rotor 4 can be efficiently rotated. Therefore, the ultrasonic motor 1 can be efficiently rotationally driven.

The structure of the stator 2 in which a plurality of piezoelectric elements are dispersedly disposed in the circumferential direction and driven to generate a traveling wave is disclosed in, for example, WO 2010/061508 A1. Note that the detailed description of the structure of generating the traveling wave is omitted since, in addition to the following description, the configuration described in WO 2010/061508 A1 is incorporated in the present description.

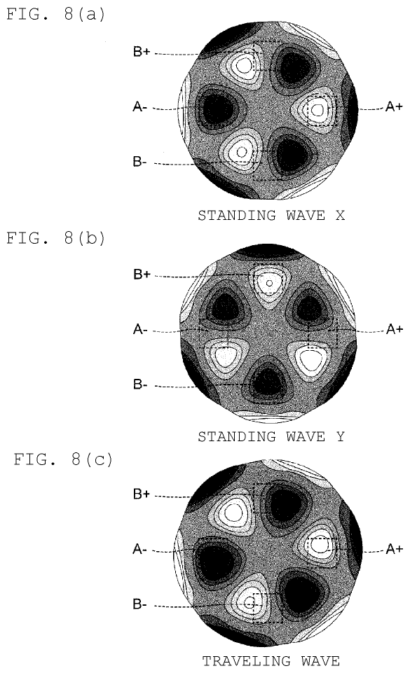

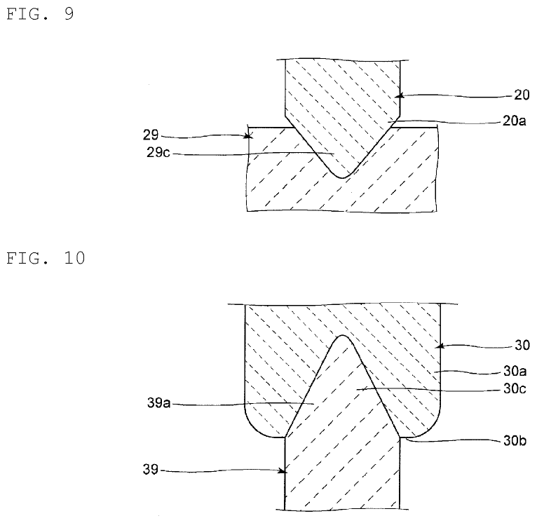

FIGS. 8(a) to 8(c) are schematic plan views of the stator for explaining the traveling wave excited in the first embodiment. Note that FIGS. 8(a) to 8(c) indicate that, in a gray scale, the closer to black, the greater the stress in one direction, and the closer to white, the greater the stress in the other direction.

FIG. 8(a) shows three standing waves X, and FIG. 8(b) shows three standing waves Y. It is assumed that the first to fourth piezoelectric elements 13A to 13D are disposed with a central angle of 90° therebetween. In this case, since the three standing waves X and Y are excited, the central angle with respect to the wavelength of the traveling wave is 120°. The central angle is determined by an angle 90° obtained by multiplying the angle 120° of one wave by ¾.

The first piezoelectric element 13A is disposed at a predetermined place where an amplitude of the three standing waves X is large, and the second to fourth piezoelectric elements 13B to 13D are disposed at intervals of the central angle of 90°. In this case, the three standing waves X and Y having phases of vibration different from each other by 90° are excited, and the three standing waves X and Y are combined to generate the traveling wave shown in FIG. 8(c).

Note that in FIGS. 8(a) to 8(c), “A+”, “A−”, “B+”, and “B−” indicate polarization directions of the piezoelectric body 14. “+” means that polarization is established from the fifth main surface 14a toward the sixth main surface 14b in a thickness direction. “−” indicates that polarization is established in an opposite direction. “A” indicates the first piezoelectric element 13A and the third piezoelectric element 13C, and “B” indicates the second piezoelectric element 13B and the fourth piezoelectric element 13D.

Note that although an example of three waves has been described, the present invention is not limited thereto, and also in the case of six waves, nine waves, twelve waves, or the like, two standing waves having a phase difference of 90° are similarly excited, and a traveling wave is generated by combining the two standing waves. In the present invention, a configuration of generating a traveling wave is not limited to the configuration shown in FIGS. 8(a) to 8(c), and various conventionally known configurations of generating the traveling wave can be used.

Hereinafter, an example of a preferred embodiment of the present invention will be described. As shown in FIG. 5, it is preferable that the plurality of fixing portions 9e of the second case member 8 are uniformly disposed in plan view. Accordingly, when the first case member 6 is fixed to the second case member 8, force can be applied more uniformly. In addition, the first case member 6 can be uniformly fixed. Accordingly, the positional displacement and tilt of the first case member 6 with respect to the second case member 8 can be more surely suppressed and the angular displacement of the shaft 10 can be more surely suppressed.

It is preferable that the plurality of support portions 9d of the second case member 8 are uniformly disposed in plan view. Accordingly, when the first case member 6 is fixed to the second case member 8, the first case member 6 can be more stably supported. Therefore, the angular displacement of the shaft 10 can be more surely suppressed.

It is preferable that the plurality of support portions 9d and the plurality of fixing portions 9e overlap with each other in plan view. In this case, when the first case member 6 is fixed to the second case member 8, force applied from each fixing portion 9e to the first case member 6 can be efficiently dispersed to each support portion 9d. Therefore, the first case member 6 can be stably fixed to the second case member 8.

In the present embodiment, the width of the support portion 9d is 2.3 mm. The width of the fixing portion 9e is 2 mm. Note that the width of each of the support portion 9d and the fixing portion 9e is a dimension of each of the support portion 9d and the fixing portion 9e along the circumferential direction of the side wall portion 9b of the second case member 8 in plan view. As described above, it is preferable that the width of the support portion 9d is wider than the width of the fixing portion 9e. Accordingly, when the first case member 6 is fixed to the second case member 8, force applied from each fixing portion 9e to the first case member 6 can be further dispersed to each support portion 9d. Therefore, the first case member 6 can be more stably fixed to the second case member 8.

As shown in FIG. 2, the first case member 6 has a pair of mounting portions 7D. The pair of mounting portions 7D are opposite to each other with the plate shape portion 7A interposed therebetween. As shown in FIG. 1, the plate shape portion 7A is located in the opening 9f of the second case member 8. On the other hand, with reference to FIG. 2 again, the mounting portion 7D extends to an outside of the second case member 8. More specifically, the side wall portion 9b of the second case member 8 is provided with a cutout portion 9g. The mounting portion 7D extends to the outside of the second case member 8 through the cutout portion 9g.

The ultrasonic motor 1 is mounted to an external part via the mounting portion 7D. For example, the mounting portion 7D may be mounted to an external part by screws, or may be adhered to an external part by an adhesion, etc. Note that the number and position of the mounting portion 7D are not limited to the above. One mounting portion 7D may be provided, or three or more mounting portions 7D may be provided.

It is preferable that the plurality of fixing portions 9e of the second case member 8 are not located outside of the mounting portion 7D in the axial direction Z. More specifically, it is preferable that the plurality of fixing portions 9e are located inside of the mounting portion 7D in the axial direction Z. Alternatively, it is preferable that the positions of the plurality of fixing portions 9e and the position of the mounting portion 7D are same in the axial direction Z. Accordingly, when the first case member 6 is fixed to the second case member 8, force can be applied easily uniformly. Thus, the perpendicularity of the shaft 10 can be easily increased. In addition, the ultrasonic motor 1 can be easily mounted to an external part via the mounting portion 7D. Thus, an accuracy of mounting of the ultrasonic motor 1 to an external part can be increased.

As shown in FIG. 2 and FIG. 4, in the present embodiment, an outer circumferential edge of the first main surface 7a of the plate shape portion 7A and a portion of the mounting portion 7D that is to be brought into contact with an external part are at the same position in the axial direction Z. Note that a portion of this outer circumferential edge that is in contact with each fixing portion 9e of the second case member 8 has a concave shape. As described above, it is preferable that the portion of the first case member 6 that is in contact with each fixing portion 9e is located inside, in the axial direction Z, of the portion of the mounting portion 7D that is to be brought into contact with an external part. By configuring as described above, it can be surely established that the plurality of fixing portions 9e of the second case member 8 are not located outside of the mounting portion 7D in the axial direction Z.

As described above, it is preferable that the first case member 6 is fixed by the second case member 8 with the crimp structure. In this case, when the first case member 6 is fixed to the second case member 8, force can be applied to the first case member 6 uniformly in a direction corresponding to the inside of the case 5 from the first main surface 7a side. According to the above, the positional displacement and tilt of the first case member 6 with respect to the second case member 8 can be more surely suppressed. Thus, the perpendicularity of the shaft 10 can be more surely increased. Therefore, the angular displacement of the shaft 10 can be more surely suppressed. In addition, since the first case member 6 and the second case member 8 do not need screws or the like, productivity can be increased. Further, the height of the ultrasonic motor 1 can be decreased and the ultrasonic motor 1 can be made small.

However, the fixation of the first case member 6 is not limited to the fixation by the crimp structure. For example, the plurality of fixing portions 9e of the second case member 8 maybe portions that fix the first case member 6 by an adhesion, or may be portions that fix the first case member 6 by welding.

Further, the first case member 6 maybe press-fitted into the second case member 8. For example, the side surface 7d of the plate shape portion 7A of the first case member 6 may have three or more convex portions each of which protrudes outside in a direction orthogonal to the axial direction Z. In this case, the plurality of fixing portions 9e are portions that are in contact with the plurality of convex portions of the plate shape portion 7A of the side wall portion 9b. Alternatively, the side wall portion 9b of the second case member 8 may have three or more convex portions for fixing the first case member 6 by press-fitting. This convex portion protrudes from the side wall portion 9b to the inside in a direction orthogonal to the axial direction Z. In this case, this convex portion is the fixing portion 9e. In the present invention, the fixing portion 9e only needs to fix at least one of the first main surface 7a and the side surface 7d of the plate shape portion 7A.

As shown in FIG. 5, it is preferable that each of the plurality of support portions 9d of the second case member 8 is a cut and raised portion. Specifically, each support portion 9d and the side wall portion 9b are configured integrally and the second case member 8 has an opening 9h that is surrounded by the support portion 9d and the side wall portion 9b. According to the above, the support portion 9d can be suppressed from being detached from the side wall portion 9b, and dimension of the support portion 9d in a direction orthogonal to the axial direction Z can be made larger. Thus, the first case member 6 can be more surely supported. In addition, the support portion 9d can be easily provided. Therefore, productivity can be increased and the angular displacement of the shaft 10 can be more surely suppressed.

However, the support portion 9d may be provided separately from the side wall portion 9b. The material of the support portion 9d and the material of the side wall portion 9b may be different from each other, and the support portion 9d may be joined to the side wall portion 9b.

FIG. 9 is a front sectional view of an example of a portion close to a tip end portion of the shaft and a positioning jig of a second embodiment.

The present embodiment is different from the first embodiment in that one end portion 20a of the shaft 20 has a cone shape. For points other than the above, the ultrasonic motor of the present embodiment has a configuration similar to that of the ultrasonic motor 1 of the first embodiment. The explanation of portions other than the shaft 20 of the ultrasonic motor incorporates the figures and the reference numerals used in the explanation of the first embodiment. Note that the cone shape in the present description includes a cone shape of which a tip end portion is rounded.

The end portion 20a shown in FIG. 9 is an end portion of the shaft 20 on the second case member 8 side. By the end portion 20a having the cone shape, the ultrasonic motor can be easily positioned. For example, a jig 29 shown in FIG. 9 is provided with a concave portion 29c having a circular cone shape. By fitting the concave portion 29c and the end portion 20a to each other, the shaft 20 can be easily and more surely positioned when the case 5 is formed. Thus, the perpendicularity of the shaft 20 can be surely and efficiently increased. In addition, and similarly to the first embodiment as shown in FIG. 1, the side wall portion 9b of the second case member 8 has at least three of the plurality of support portions 9d and at least three of the plurality of fixing portions 9e, and the first case member 6 is fixed by the plurality of fixing portions 9e. Therefore, the angular displacement of the shaft 20 can be efficiently suppressed.

Note that the shape of the end portion 20a of the shaft 20 is not limited to the circular cone shape, and may be a pyramid shape. Further, at least one of both end portions of the shaft 20 only needs to have a cone shape. Thus, the end portion of the shaft 20 on the first case member 6 side may have a cone shape.

In the present embodiment, the end portion 20a of the shaft 20 has a convex shape. However, the end portion 20a may have a concave shape. For example, in a modification example of the second embodiment shown in FIG. 10, an end portion 30a of a shaft 30 has a cone-shaped concave portion 30c. Specifically, a tip end portion 30b of the shaft 30 is provided with the concave portion 30c. The concave portion 30c has a circular cone shape. However, the concave portion 30c may have a pyramid shape. For example, a jig 39 shown in FIG. 10 is provided with a convex portion 39a having a circular cone shape. By fitting the convex portion 39a and the concave portion 30c to each other, the shaft 30 can be easily and more surely positioned. Thus, the perpendicularity of the shaft 30 can be surely and efficiently increased. Therefore, the angular displacement of the shaft 30 can be efficiently suppressed.

In addition, since the shaft 30 need not be provided with a convex portion, the shaft 30 can be made shorter. Therefore, the height of the ultrasonic motor can be decreased and the ultrasonic motor can be made small.

### DESCRIPTION OF REFERENCE SYMBOLS

1: Ultrasonic motor
2: Stator
3: Vibrating body
3a, 3b: Third and fourth main surfaces
3c: Through hole
3e: Protrusion portion
4: Rotor
4a: Concave portion
4b: Side wall portion
4c: Through hole
4d: End surface
5: Case
6: First case member
7A: Plate shape portion
7B, 7C: First and second protruding portions
7D: Mounting portion
7a, 7b: First and second main surfaces
7c: Through hole
7d: Side surface
8: Second case member
9A: Cup shape portion
9B: Protruding portion
9a: Bottom portion
9b: Side wall portion
9d: Support portion
9e: Fixing portion
9f: Opening
9g: Cutout portion
9h: Opening
10: Shaft

10a: Wide portion
12: Elastic member
13A to 13D: First to fourth piezoelectric elements
14: Piezoelectric body
14a, 14b: Fifth and sixth main surfaces
15A, 15B: First and second electrodes
16: Spring member
16c: Through hole
17: Snap ring
18, 19: First and second bearing portions
20: Shaft
20a: End portion
29: Jig
29c: Concave portion
30: Shaft
30a: End portion
30b: Tip end portion
30c: Concave portion
39: Jig
39a: Convex portion

1. An ultrasonic motor comprising:
a shaft;
a case that includes:
a first case member having a plate shape portion including a first main surface and a second main surface that face opposite to each other and a side surface connecting the first main surface and the second main surface;
a first bearing portion attached to the first case member and that supports the shaft;
a second case member disposed on a second main surface side of the first case member, and having a cup shape portion including a bottom portion and a side wall portion connected to the bottom portion, wherein the side wall portion of the second case member has a plurality of support portions that protrude toward an inside of the case and support the second main surface of the first case member, and a plurality of fixing portions that fix at least one of the first main surface and the side surface of the first case member to the second case member; and
a second bearing portion attached to the second case member and that supports the shaft;
a stator disposed in the case and having a plate-shaped vibrating body including a third main surface and a fourth main surface that face opposite to each other, and a piezoelectric element on the third main surface of the vibrating body; and
a rotor disposed in the case, fixed to the shaft, and in contact with the fourth main surface of the vibrating body.

2. The ultrasonic motor according to claim 1, wherein the plurality of support portions is at least three support portions.

3. The ultrasonic motor according to claim 1, wherein the plurality of fixing portions is at least three fixing portions.

4. The ultrasonic motor according to claim 1, wherein the plurality of fixing portions of the second case member are disposed uniformly in a plan view of the ultrasonic motor.

5. The ultrasonic motor according to claim 4, wherein the plurality of support portions of the second case member are disposed uniformly in the plan view of the ultrasonic motor.

6. The ultrasonic motor according to claim 5, wherein the plurality of support portions and the plurality of fixing portions overlap each other in the plan view of the ultrasonic motor.

7. The ultrasonic motor according to claim 1, wherein the plurality of support portions of the second case member are disposed uniformly in a plan view of the ultrasonic motor.

8. The ultrasonic motor according to claim 1, wherein
the first case member has a mounting portion configured to be mounted to an external part, and
the plurality of fixing portions of the second case member are not located outside of the mounting portion in a direction in which the shaft extends.

9. The ultrasonic motor according to claim 1, wherein the plurality of support portions and the plurality of fixing portions overlap each other in a plan view of the ultrasonic motor.

10. The ultrasonic motor according to claim 1, wherein, when a dimension of each of the plurality of support portions and the plurality of fixing portions along a circumferential direction of the side wall portion of the second case member in a plan view of the ultrasonic motor is a width of each of the plurality of support portions and the plurality of fixing portions, the width of each of the plurality of support portions is larger than a width of each of the plurality of fixing portions.

11. The ultrasonic motor according to claim 1, wherein the plurality of fixing portions are each a crimp structure.

12. The ultrasonic motor according to claim 1, wherein each of the plurality of support portions of the second case member are a cut and raised portion in which the side wall portion is cut and raised from an outside to an inside of the case.

13. The ultrasonic motor according to claim 1, wherein each of the first bearing portion and the second bearing portion is a sliding bearing made of resin.

14. The ultrasonic motor according to claim 1, wherein an end portion of the shaft has a cone shape.

15. The ultrasonic motor according to claim 1, wherein a tip end portion of the shaft has a cone-shaped concave portion.

16. The ultrasonic motor according to claim 1, wherein the first case member includes a first protruding portion that protrudes to the outside of the case and holds the first bearing portion.

17. The ultrasonic motor according to claim 16, wherein the first case member includes a second protruding portion that protrudes to the inside of the case and extends into a hole in the stator.

18. The ultrasonic motor according to claim 16, wherein the second case member includes a second protruding portion that protrudes to the outside of the case and holds the second bearing portion.
